(19) United States
(12) Patent Application Publication
(10) Pub. No.: US 2025/0329870 A1
(43) Pub. Date: Oct. 23, 2025

(54) Power Storage Device and Vehicle

(71) Applicant: TOYOTA JIDOSHA KABUSHIKI KAISHA, Toyota-shi Aichi-ken (JP)

(72) Inventors: Shigeyuki INOUE, Toyota-shi Aichi-ken (JP); Kazuki SUGIE, Miyoshi-shi Aichi-ken (JP); Yuki TAKAHASHI, Miyoshi-shi Aichi-ken (JP)

(73) Assignee: TOYOTA JIDOSHA KABUSHIKI KAISHA, Toyota-shi Aichi-ken (JP)

(21) Appl. No.: 19/178,946

(22) Filed: Apr. 15, 2025

(30) Foreign Application Priority Data
Apr. 18, 2024 (JP) 2024-067363

(51) Int. Cl. H01M 50/30; H01M 10/42; H01M 10/613; H01M 10/625; H01M 50/204; H01M 50/249; H01M 50/271; H01M 50/507

(52) U.S. Cl. CPC H01M 50/394; H01M 10/425; H01M 10/613; H01M 10/625; H01M 50/249; H01M 50/271; H01M 50/507; H01M 50/204

(57) ABSTRACT

A power storage device includes: a first power storage stack; a second power storage stack spaced from the first power storage stack; an accommodating case including an upper cover and a lower case and housing the first power storage stack and the second power storage stack; and a breathing film provided on the accommodating case. A space extending in a first direction is formed in the power storage device. The space passes through at least an inter-stack region located between the first power storage stack and the second power storage stack. The breathing film is provided on the upper cover and located above the space.

### CROSS REFERENCE TO RELATED APPLICATIONS

This nonprovisional application is based on Japanese Patent Application No. 2024-067363 filed on Apr. 18, 2024 with the Japan Patent Office, the entire contents of which are hereby incorporated by reference.

### BACKGROUND

### Field

The present disclosure relates to a power storage device and a vehicle including the power storage device.

### Description of the Background Art

For example, WO2020/134054 discloses a power storage device (battery pack) in which a plurality of power storage cells are arranged on both sides of a space extending in one direction.

### SUMMARY

Generally, a power storage device is equipped with a cooler for cooling power storage cells. As high-temperature power storage cells are cooled, condensation water is generated. If the condensation water is kept accumulated in the power storage device, a fault occurs such as short circuit between power storage cells adjacent to each other. It is therefore required to suppress condensation water from being kept accumulated in the power storage device.

One object of the present disclosure is to suppress condensation water from being kept accumulated in the power storage device.
(1) A power storage device according to an aspect of the present disclosure includes: a first power storage stack; a second power storage stack spaced from the first power storage stack; an accommodating case including an upper cover and a lower case and housing the first power storage stack and the second power storage stack; and a breathing film provided on the accommodating case. A space extending in a first direction is formed in the power storage device. The space passes through at least an inter-stack region located between the first power storage stack and the second power storage stack. The breathing film is provided on the upper cover and located above the space.
(2) In the power storage device according to (1) above, the breathing film is located above the inter-stack region.
(3) In the power storage device according to (2) above, a first connection member is electrically connected to the first power storage stack. A second connection member is electrically connected to the second power storage stack. The first connection member and the second connection member are located in the inter-stack region.
(4) In the power storage device according to (1) above, the first power storage stack and the second power storage stack are arranged in a second direction, and the power storage device further includes: a first junction box located adjacent to the first power storage stack in the first direction; and a second junction box located adjacent to the second power storage stack in the first direction, and located adjacent to the first junction box in the second direction. The first junction box is electrically connected to the first power storage stack. The second junction box is electrically connected to the second power storage stack. The space passes through an inter-box region located between the first junction box and the second junction box. The breathing film is located above the inter-box region.
(5) A vehicle according to another aspect of the present disclosure includes the power storage device according to any one of (1) to (4) above. The breathing film is located below a center tunnel of the vehicle.
(6) In the vehicle according to (5) above, at least one end portion of the center tunnel is provided with a lid.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a side view schematically showing a vehicle including a power storage device according to an embodiment of the present disclosure.

FIG. 2 is a perspective view schematically showing the power storage device 1.

FIG. 3 is a perspective view schematically showing a state in which the upper cover is removed from the power storage device 1.

FIG. 4 is a plan view schematically showing a state in which the upper cover is removed from the power storage device 1.

FIG. 5 is a cross-sectional view taken along line V-V in FIG. 4.

FIG. 6 is a cross-sectional view taken along line VI-VI in FIG. 4.

FIG. 7 is a perspective view schematically showing the floor panel 4 and the power storage device 1.

FIG. 8 is a perspective view schematically showing a power storage device according to a modification.

FIG. 9 is a plan view schematically showing a state in which an upper cover is removed from a power storage device according to a modification.

FIG. 10 is a cross-sectional view taken along line X-X in FIG. 9.

FIG. 11 is a cross-sectional view taken along line XI-XI in FIG. 9.

### DESCRIPTION OF THE EMBODIMENTS

Hereinafter, embodiments and modifications according to the present disclosure will be described with reference to the drawings. In the following description, the same parts and components are denoted by the same reference numerals. Their names and functions are also the same. Therefore, detailed description thereof will not be repeated. The embodiments and modifications described below may be selectively combined as appropriate.

### Embodiment

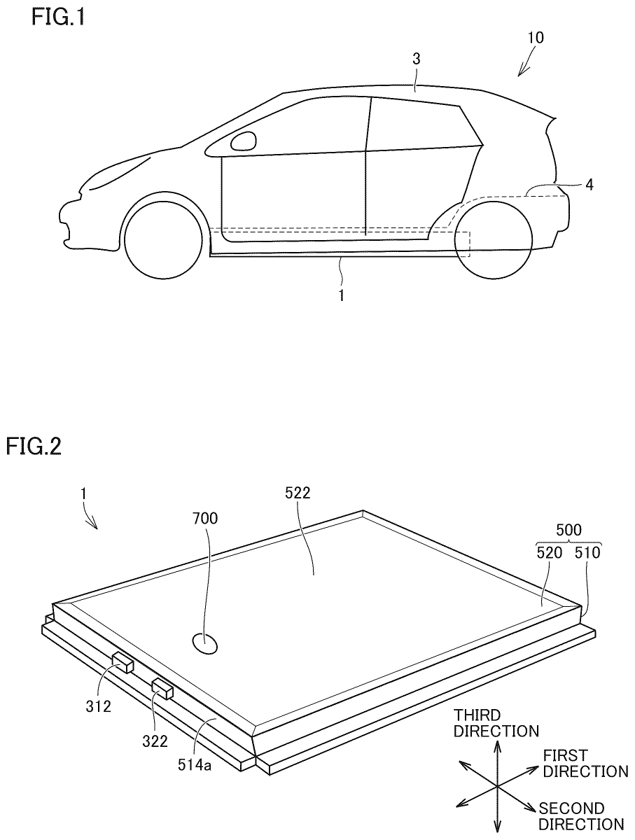

A power storage device according to an embodiment of the present disclosure will be described with reference to FIGS. 1 to 7. FIG. 1 is a side view schematically showing a vehicle including a power storage device according to an embodiment of the present disclosure.

Referring to FIG. 1, a vehicle 10 includes a power storage device 1 and a vehicle skeleton 3. The power storage device 1 is disposed below the floor panel 4 of the vehicle 10. Examples of the vehicle 10 may include a hybrid electric vehicle, a plug-in hybrid electric vehicle, a fuel cell electric vehicle, and a battery electric vehicle.

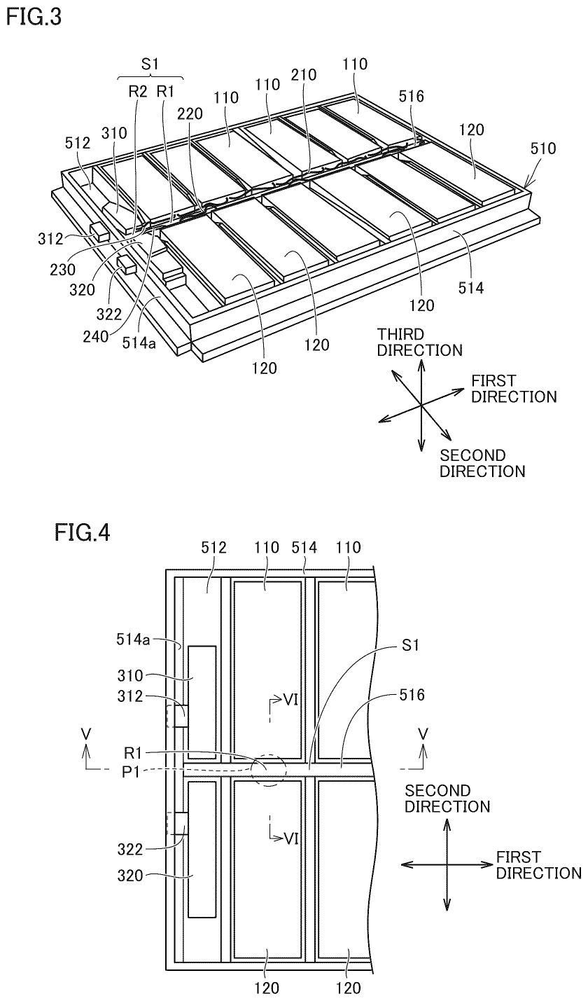

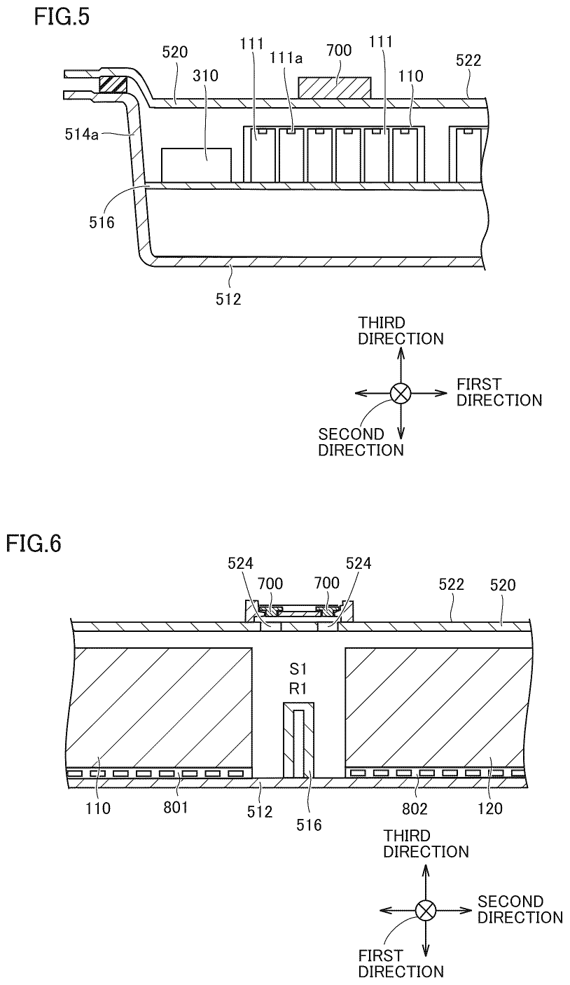

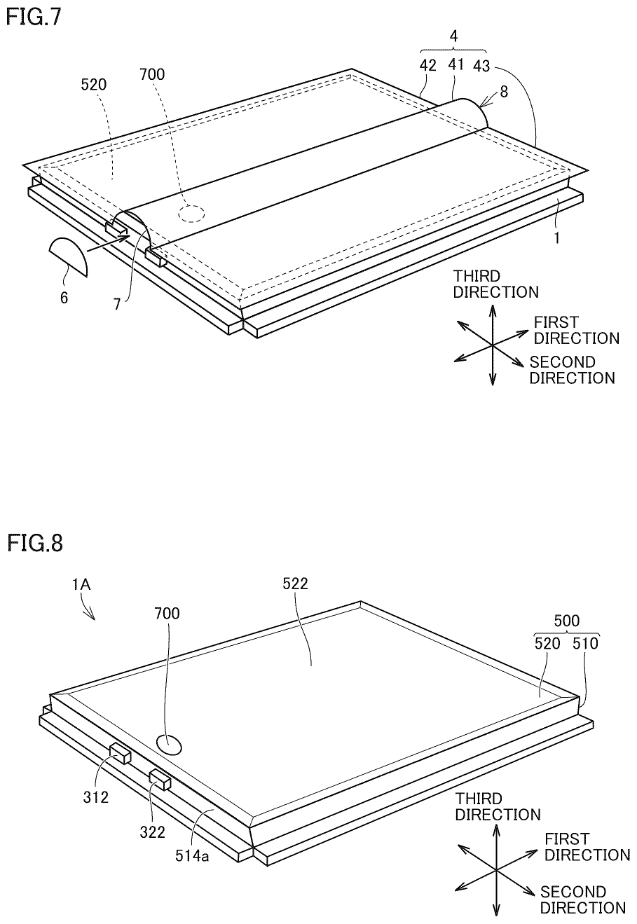

FIG. 2 is a perspective view schematically showing the power storage device 1. FIG. 3 is a perspective view schematically showing a state in which the upper cover is removed from the power storage device 1. FIG. 4 is a plan view schematically showing a state in which the upper cover is removed from the power storage device 1. FIG. 5 is a cross-sectional view taken along line V-V in FIG. 4. FIG. 6 is a cross-sectional view taken along line VI-VI in FIG. 4. FIG. 7 is a perspective view schematically showing the floor panel 4 and the power storage device 1.

Referring to FIGS. 2 and 3, the power storage device 1 includes a plurality of first power storage stacks 110, a plurality of second power storage stacks 120, a first bus bar 210, a second bus bar 220, a first junction box 310, a second junction box 320, a first wiring 230, a second wiring 240, a case 500, a breathing film 700, and coolers 801 and 802 (see FIG. 6).

Referring to FIG. 3, a space S1 extending in the first direction is formed in the power storage device 1. The space S1 is a passage of air in the case 500 (see FIG. 2). The first direction corresponds to the front-rear direction of the vehicle 10 (see FIG. 1). The space S1 passes through an inter-stack region R1 located between the first power storage stack 110 and the second power storage stack 120. The space S1 passes through an inter-box region R2 located between the first junction box 310 and the second junction box 320.

The plurality of first power storage stacks 110 are arranged side by side in the first direction. In the present embodiment, the plurality of first power storage stacks 110 includes six first power storage stacks 110. However, the number of the first power storage stacks 110 is not limited to six. The number of the first power storage stacks 110 may be one or more. Each first power storage stack 110 is formed in a rectangular parallelepiped shape elongated in the second direction. The second direction corresponds to the width direction of the vehicle 10 (see FIG. 1). The second direction corresponds to the arrangement direction of the first power storage stack 110 and the second power storage stack 120. The third direction corresponds to the height direction of the power storage device 1 (see FIG. 2). The first direction is orthogonal to both the second direction and the third direction. The second direction is orthogonal to both the first direction and the third direction. The third direction is orthogonal to both the first direction and the second direction.

Referring to FIG. 5, each first power storage stack 110 includes a plurality of power storage cells 111. The plurality of power storage cells 111 are arranged, for example, in the first direction. The plurality of power storage cells 111 may be arranged in the second direction. Each of the power storage cells 111 is formed in a flat rectangular parallelepiped shape. Each of the power storage cells 111 may be, for example, a lithium ion battery. Each of the power storage cells 111 may be configured by an all-solid-state battery using a solid electrolyte. As shown in FIG. 5, each power storage cell 111 includes a cell smoke discharge valve 111a provided on the upper surface of the housing of the power storage cell 111.

Referring to FIG. 6, the cooler 801 is provided along the lower surface of the first power storage stack 110. The cooler 801 cools the power storage cell 111 (see FIG. 5).

With reference to FIG. 3, the second power storage stack 120 is spaced apart from the first power storage stack 110 in the second direction. More specifically, the plurality of second power storage stacks 120 face the plurality of first power storage stacks 110 in the second direction. The plurality of second power storage stacks 120 are arranged side by side in the first direction. In the present embodiment, the plurality of second power storage stacks 120 includes six second power storage stacks 120. However, the number of second power storage stacks 120 is not limited to six. The number of the second power storage stacks 120 may be one or more. The configuration of each second power storage stack 120 is the same as the configuration of the first power storage stack 110.

Referring to FIG. 6, the cooler 802 is provided along the lower surface of the second power storage stack 120. The cooler 802 cools the power storage cells included in the second power storage stack 120.

Referring to FIG. 3, the first bus bar 210 electrically connects a pair of first power storage stacks 110 adjacent to each other in the first direction. The first bus bar 210 is an example of the “first connection member” in the present disclosure. That is, the first bus bar 210 electrically connected to the first power storage stack 110 is connected to the first power storage stack 110. The second bus bar 220 electrically connects a pair of second power storage stacks 120 adjacent to each other in the first direction. The second bus bar 220 is an example of the “second connection member” in the present disclosure. That is, the second bus bar 220 electrically connected to the second power storage stack 120 is connected to the second power storage stack 120. The first bus bar 210 and the second bus bar 220 are disposed in the inter-stack region R1.

The first junction box 310 is disposed at a position facing the first power storage stack 110 in the first direction. More specifically, the first junction box 310 is disposed at a position adjacent to the first power storage stack 110 disposed on the outermost side in the first direction among the plurality of first power storage stacks 110 in the first direction.

The first junction box 310 accommodates relays, fuses, and the like. The first wiring 230 electrically connects the first junction box 310 and the first power storage stack 110 disposed on the outermost side in the first direction among the plurality of first power storage stacks 110. That is, the first junction box 310 is electrically connected to the first power storage stack 110 disposed on the outermost side in the first direction among the plurality of first power storage stacks 110. The first junction box 310 has a first connector 312. The first connector 312 protrudes outward in the first direction.

The second junction box 320 faces the second power storage stack 120 in the first direction. The second junction box 320 is disposed at a position facing the first junction box 310 with a space from the first junction box 310 in the second direction. More specifically, the second junction box 320 is disposed at a position adjacent to the second power storage stack 120 disposed on the outermost side in the first direction among the plurality of second power storage stacks 120 in the first direction. The second junction box 320 is disposed at a position adjacent to the first junction box 310 in the second direction.

The second junction box 320 accommodates relays, fuses, and the like. The second wiring 240 electrically connects the second junction box 320 and the second power storage stack 120 disposed on the outermost side in the first direction among the plurality of second power storage stacks 120. That is, the second junction box 320 is electrically connected to the second power storage stack 120 disposed on the outermost side in the first direction among the plurality of second power storage stacks 120. The second junction box 320 has a second connector 322. The second connector 322 protrudes outward in the first direction.

A part of the first wiring 230 and a part of the second wiring 240 are disposed in the inter-box region R2.

With reference to FIGS. 2 and 3, the case 500 is an example of the “accommodating case” in the present disclosure. The case 500 houses the plurality of first power storage stacks 110, the plurality of second power storage stacks 120, the first bus bar 210, the second bus bar 220, the first junction box 310, the second junction box 320, the first wiring 230, the second wiring 240, and the coolers 801 and 802 (see FIG. 6). The case 500 includes a lower case 510 and an upper cover 520.

Referring to FIG. 3, the lower case 510 is open upward. The lower case 510 includes a bottom wall 512, a peripheral wall 514, and a partition portion 516.

The bottom wall 512 supports the plurality of first power storage stacks 110 and the plurality of second power storage stacks 120. The peripheral wall 514 stands from the peripheral edge of the bottom wall 512. The peripheral wall 514 surrounds the plurality of first power storage stacks 110 and the plurality of second power storage stacks 120. The peripheral wall 514 is formed in a substantially quadrangular cylindrical shape.

The peripheral wall 514 includes a side wall 514a facing the first power storage stack 110 and the second power storage stack 120 in the first direction. The side wall 514a extends along the second direction. The side wall 514a is inclined so as to be gradually separated from the first power storage stack 110 and the second power storage stack 120 toward the upper side. However, the side wall 514a may be orthogonal to the bottom wall 512.

The partition portion 516 partitions the plurality of first power storage stacks 110 from the plurality of second power storage stacks 120. The partition portion 516 has a shape extending along the first direction. The height of the partition portion 516 is lower than the height of the peripheral wall 514. As illustrated in FIG. 3, the first bus bar 210, the second bus bar 220, the first wiring 230, and the second wiring 240 are disposed on the partition portion 516.

Referring to FIGS. 2 and 3, the upper cover 520 accommodates, together with the lower case 510, the plurality of first power storage stacks 110, the plurality of second power storage stacks 120, the first bus bar 210, the second bus bar 220, the first junction box 310, the second junction box 320, the first wiring 230, the second wiring 240, and the coolers 801 and 802 (see FIG. 6). The peripheral edge portion of the upper cover 520 is fixed to the upper end portion of the peripheral wall 514 by bolts or the like.

The upper cover 520 has an upper wall 522. The upper wall 522 faces the bottom wall 512. The upper wall 522 covers the plurality of first power storage stacks 110, the plurality of second power storage stacks 120, the first bus bar 210, the second bus bar 220, the first junction box 310, the second junction box 320, the first wiring 230, the second wiring 240, and the coolers 801 and 802 (see FIG. 6).

Referring to FIG. 2, the breathing film 700 is provided on the case 500. The breathing film 700 is provided on the upper wall 522 of the upper cover 520. The breathing film 700 is formed of, for example, Gore Tex (registered trademark) or the like. The breathing film 700 regulates the pressure in the case 500 by allowing the passage of gas between the inside of the case 500 and the outside of the case 500.

For example, when the temperature of the power storage device 1 rises, the internal pressure in the case 500 may become higher than the external pressure of the case 500. In this case, the air in the case 500 is discharged to the outside of the case 500 through the breathing film 700. Depending on the external environment, the internal pressure in the case 500 may be lower than the external pressure of the case 500. In this case, outside air enters the case 500 through the breathing film 700.

That is, the breathing film 700 plays a role of maintaining the internal pressure in the case 500 within a predetermined range. In addition, since the air in the case 500 is discharged to the outside of the case 500 through the breathing film 700, water vapor contained in the air is also discharged to the outside of the case 500 through the breathing film 700. Therefore, the breathing film 700 also plays a role of ventilation of the power storage device 1.

Referring to FIG. 4, position P1 indicates the position of the breathing film 700 when the upper cover 520 is attached to the power storage device 1. In FIG. 4, the first bus bar 210, the second bus bar 220, the first wiring 230, and the second wiring 240 illustrated in FIG. 3 are not illustrated.

Referring to FIG. 6, the breathing film 700 is provided on the upper cover 520 and located above space S1, which is a passage of air in the case 500. Specifically, a through hole 524 is formed in the upper cover 520. The breathing film 700 is attached to the upper wall 522 of the upper cover 520 so as to cover the through hole 524. As shown in FIG. 6, the breathing film 700 is provided on the upper cover 520 and located above the inter-stack region R1. Note that the breathing film 700 may be provided on the upper cover 520 and located above the space S1, which is a passage of air in the case 500, and may not be provided above the inter-stack region R1.

Referring to FIG. 7, the breathing film 700 is provided on the upper cover 520 of the power storage device 1 disposed below the floor panel 4. That is, the breathing film 700 is disposed below the floor panel 4. More specifically, the floor panel 4 includes a center tunnel 41 extending in the first direction and flat portions 42 and 43 connected to the center tunnel 41. The flat portion 42 is disposed on the right side of the center tunnel 41. The flat portion 43 is disposed on the left side of the center tunnel 41. The center tunnel 41 includes an end portion 7 and an end portion 8 which are arranged at intervals in the first direction. The end portion 7 is closer to the front of the vehicle 10 than the end portion 8, and the end portion 8 is closer to the rear of the vehicle 10 than the end portion 7.

The breathing film 700 is disposed below the center tunnel 41 of the vehicle 10. At least one of the two end portions 7 and 8 of the center tunnel 41 is provided with a lid 6. In the example shown in FIG. 7, the lid 6 is provided at the end portion 7.

The lid 6 may be provided on the end portion 8. The lids 6 may be provided at the end portion 7 and the end portion 8. Further, the lid 6 may be provided with a notch through which wiring or the like passes. In addition, the lid 6 may not be provided at either the end portion 7 or the end portion 8. Further, the breathing film 700 may be disposed below the flat portion 42 or the flat portion 43.

Effects of the power storage device 1 according to the present embodiment will be described.

### Effect 1

In general, condensation water is generated when a high-temperature power storage cell is cooled. The condensation water evaporates and is changed into water vapor, and the water vapor is discharged to the outside of the power storage device through the breathing film. However, water vapor into which condensation water generated at a location far from the breathing film is changed is difficult to reach the breathing film and stays in the power storage device. The condensation water generated at a location far from the breathing film is, for example, condensation water generated by cooling the power storage cell far from the breathing film.

On the other hand, in the power storage device 1 according to the present embodiment, the breathing film 700 is provided on the upper cover 520 and located above the space S1 (see FIG. 3) which is a passage of air in the case 500. Therefore, even water vapor into which condensation water generated at a location far from the breathing film 700 is changed can reach the breathing film 700 by moving along the space S1. The water vapor that has reached the breathing film 700 is discharged to the outside of the case 500 through the breathing film 700. Therefore, according to the power storage device 1 of the present embodiment, water vapor is easily discharged to the outside of the case 500 through the breathing film 700. That is, according to the power storage device 1 of the present embodiment, ventilation of the power storage device 1 is easily performed. Therefore, according to the power storage device 1 of the present embodiment, it is possible to suppress condensation water from being kept accumulated in the power storage device 1.

### Effect 2

In the power storage device 1 according to the present embodiment, the breathing film 700 is provided on the upper cover 520 and located above the inter-stack region R1 (see FIG. 3). Since the first bus bar 210 and the second bus bar 220 are disposed in the inter-stack region R1, the inter-stack region R1 is likely to warm. Since the dew point temperature rises as the air warms, the amount of moisture that can be contained in the air increases. That is, in the inter-stack region R1 where the air is likely to warm, the amount of moisture that can be contained in the air is large. Therefore, water vapor is likely to gather in the inter-stack region R1. In the power storage device 1 according to the present embodiment, the breathing film 700 is provided on the upper cover 520 and located above the inter-stack region R1 where water vapor easily gathers. Therefore, according to the power storage device 1 of the present embodiment, water vapor is efficiently discharged to the outside of the case 500 through the breathing film 700.

### Effect 3

In the power storage device 1 according to the present embodiment, the breathing film 700 is provided on the upper cover 520 of the power storage device 1 disposed below the floor panel 4 (see FIG. 7). Therefore, as compared with the case where the breathing film 700 is provided on the peripheral wall 514 (see FIG. 3) of the case 500, adhesion of foreign matter to the breathing film 700 is suppressed. The foreign matter includes at least one of dust, stones, sand, and rainwater. When foreign matter adheres to the breathing film 700, the breathability of the breathing film 700 decreases. However, according to the power storage device 1 of the present embodiment, since it is possible to suppress adhesion of foreign matter to the breathing film 700, it is possible to suppress a decrease in breathability of the breathing film 700.

### Effect 4

In the power storage device 1 according to the present embodiment, the breathing film 700 is disposed below the center tunnel 41 (see FIG. 7). Therefore, it is possible to effectively suppress foreign matter from entering the region where the breathing film 700 is provided from the width direction (second direction) of the vehicle 10.

### Effect 5

In the power storage device 1 according to the present embodiment, the lid 6 is provided at at least one of the two end portions 7 and 8 of the center tunnel 41. Accordingly, it is possible to effectively suppress foreign matter from entering the region where the breathing film 700 is provided from the front-rear direction (first direction) of the vehicle 10. In the case where the lid 6 is provided at the end portion 7, it is possible to effectively suppress intrusion of foreign matter from the front of the vehicle 10 into the region where the breathing film 700 is provided. In the case where the lid 6 is provided at the end portion 8, it is possible to effectively suppress the intrusion of foreign matter from the rear of the vehicle 10 into the region where the breathing film 700 is provided. While the vehicle 10 is traveling, foreign matter is likely to enter from the front of the vehicle 10. Therefore, providing the lid 6 at the end portion 7 can effectively suppress foreign matter from entering the region where the breathing film 700 is provided.

### Effect 6

In the power storage device 1 according to the present embodiment, the lid 6 is provided at at least one of the two end portions 7 and 8 of the center tunnel 41. Accordingly, vibration in the vehicle is suppressed while the vehicle 10 is traveling. Therefore, the case where the lid 6 is provided in the center tunnel 41 is more cost-effective than the case where the power storage device 1 is provided with a protective cover for protecting the breathing film 700.

### Effect 7

According to the power storage device 1 of the present embodiment, it is possible to suppress adhesion of foreign matter to the breathing film 700. Therefore, according to the power storage device 1 of the present embodiment, damage to the breathing film 700 is suppressed.

### Effect 8

According to the power storage device 1 of the present embodiment, since it is possible to suppress adhesion of foreign matter to the breathing film 700, it is not necessary to provide a protective cover for protecting the breathing film 700 in the power storage device 1. Therefore, according to the power storage device 1 of the present embodiment, it is possible to suppress the number of components necessary for the power storage device 1.

### Modification

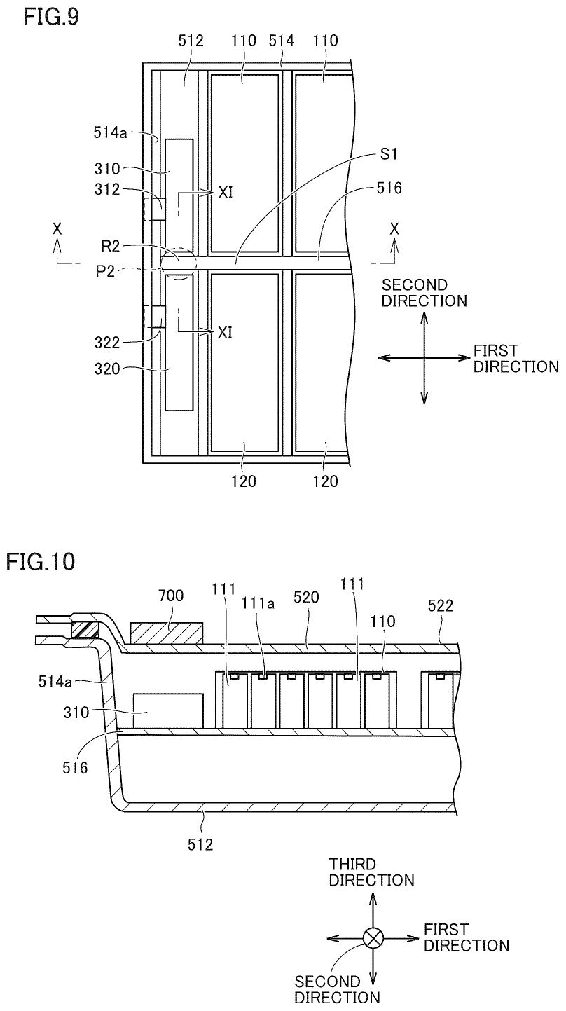

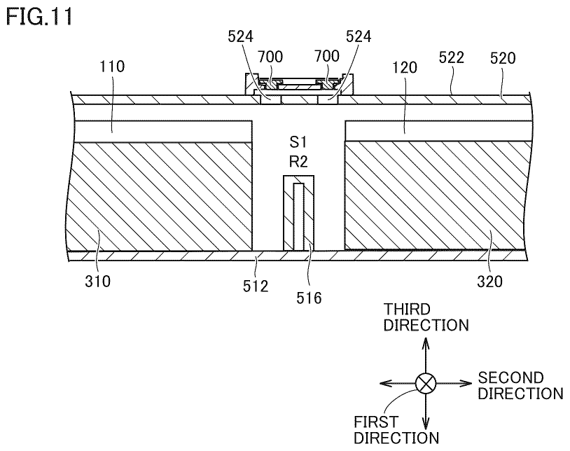

A modification of the position of the breathing film 700 will be described with reference to FIGS. 8 to 11. FIG. 8 is a perspective view schematically showing a power storage device according to a modification. FIG. 9 is a plan view schematically showing a state in which an upper cover is removed from a power storage device according to a modification. FIG. 10 is a cross-sectional view taken along line X-X in FIG. 9. FIG. 11 is a cross-sectional view taken along line XI-XI in FIG. 9.

Referring to FIG. 8, power storage device 1A in the modification is also disposed below floor panel 4 (see FIG. 1) of the vehicle 10 (see FIG. 1). Also in the power storage device 1A, the breathing film 700 is provided on the case 500. The breathing film 700 is provided on the upper wall 522 of the upper cover 520. Referring to FIG. 9, position P2 indicates the position of the breathing film 700 when the upper cover 520 is attached to power storage device 1A. In FIG. 9, the first bus bar 210, the second bus bar 220, the first wiring 230, and the second wiring 240 illustrated in FIG. 3 are not illustrated.

Referring to FIG. 11, the breathing film 700 is provided on the upper cover 520 and located above space S1 which is a passage of air in case 500. Specifically, a through hole 524 is formed in the upper cover 520. The breathing film 700 is attached to the upper wall 522 of the upper cover 520 so as to cover the through hole 524. As shown in FIG. 11, the breathing film 700 is provided on the upper cover 520 and located above the inter-box region R2. As described above, the inter-box region R2 is a region located between the first junction box 310 and the second junction box 320. Note that the breathing film 700 may be provided on the upper cover 520 and located above the space S1 which is a passage of air in the case 500, and may not be provided above the inter-box region R2.

Referring to FIGS. 10 and 11, the height of the first junction box 310 is lower than the height of the first power storage stack 110. The height of the first junction box 310 is the length of the first junction box 310 in the third direction. The height of the first power storage stack 110 is the length of the first power storage stack 110 in the third direction. The height of the second junction box 320 is lower than the height of the second power storage stack 120. The height of the second junction box 320 is the length of the second junction box 320 in the third direction. The height of the second power storage stack 120 is the length of the second power storage stack 120 in the third direction. Therefore, a space wider than the inter-stack region R1 (see FIG. 3) is formed in the inter-box region R2. The breathing film 700 is provided on the upper cover 520 and located above the inter-box region R2 where a wide space is formed.

Referring to FIG. 7, also in the modification, the breathing film 700 is disposed below the floor panel 4. Also in the modification, the breathing film 700 is disposed below the center tunnel 41. Also in the modification, the lid 6 is provided at the end portion 7.

Also in the modification, the lid 6 may be provided on the end portion 8. Also in the modification, the lids 6 may be provided at the end portion 7 and the end portion 8. Also in the modification, the lid 6 may be provided with a notch through which wiring or the like passes. Further, also in the modification, the lid 6 may not be provided at either the end portion 7 or the end portion 8. Also in the modification, the breathing film 700 may be disposed below the flat portion 42 or the flat portion 43.

Except for the position of the breathing film 700, the power storage device 1A in the modification is the same as the power storage device 1 (see FIG. 2).

As described above, in the power storage device 1A according to the modification, the breathing film 700 is provided on the upper cover 520 and located above the space S1 (see FIGS. 9 and 11) which is the passage of the air in the case 500. Therefore, even water vapor into which condensation water generated at a location far from the breathing film 700 is changed can reach the breathing film 700 by moving along the space S1. The water vapor that has reached the breathing film 700 is discharged to the outside of the case 500 through the breathing film 700. Therefore, according to the power storage device 1A of the modification, water vapor is easily discharged to the outside of the case 500 through the breathing film 700. That is, according to the power storage device 1A of the modification, ventilation of the power storage device 1A is easily performed. Therefore, according to the power storage device 1A of the modification, it is possible to suppress the condensation water from being kept accumulated in the power storage device 1A.

In the power storage device 1A according to the modification, the breathing film 700 is provided on the upper cover 520 and located above the inter-box region R2. The first junction box 310 and the second junction box 320 are easily warmed. Therefore, the inter-box region R2 located between the first junction box 310 and the second junction box 320 is likely to warm. A part of the first wiring 230 and a part of the second wiring 240 are disposed in the inter-box region R2. Therefore, the inter-box region R2 is likely to warm. In the inter-box region R2 where the air is likely to warm, the amount of moisture that can be contained in the air is large. Therefore, water vapor is likely to gather in the inter-box region R2. In the power storage device 1A according to the modification, the breathing film 700 is provided on the upper cover 520 and located above the inter-box region R2 where water vapor easily gathers. Therefore, according to the power storage device 1A of the modification, water vapor is efficiently discharged to the outside of the case 500 through the breathing film 700.

In the power storage device 1A according to the modification, the breathing film 700 is provided on the upper cover 520 and located above the inter-box region R2 in which a wide space is formed. When a wide space is formed at the position where the breathing film 700 is provided, breathability is good. Therefore, according to the power storage device 1A of the modification, water vapor is efficiently discharged to the outside of the case 500 through the breathing film 700.

In addition, the power storage device 1A according to the modification further exhibits the above-described Effect 3, the above-described Effect 4, the above-described Effect 5, the above-described Effect 6, the above-described Effect 7, and the above-described Effect 8.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A power storage device comprising:
a first power storage stack;
a second power storage stack spaced from the first power storage stack;
an accommodating case including an upper cover and a lower case and housing the first power storage stack and the second power storage stack; and
a breathing film provided on the accommodating case, wherein
a space extending in a first direction is formed in the power storage device,
the space passes through at least an inter-stack region located between the first power storage stack and the second power storage stack, and
the breathing film is provided on the upper cover and located above the space.

2. The power storage device according to claim 1, wherein the breathing film is located above the inter-stack region.

3. The power storage device according to claim 2, wherein
a first connection member is electrically connected to the first power storage stack,
a second connection member is electrically connected to the second power storage stack, and
the first connection member and the second connection member are located in the inter-stack region.

4. The power storage device according to claim 1, wherein
the first power storage stack and the second power storage stack are arranged in a second direction,
the power storage device further comprises:
a first junction box located adjacent to the first power storage stack in the first direction; and
a second junction box located adjacent to the second power storage stack in the first direction, and located adjacent to the first junction box in the second direction,
the first junction box is electrically connected to the first power storage stack,
the second junction box is electrically connected to the second power storage stack,
the space passes through an inter-box region located between the first junction box and the second junction box, and
the breathing film is located above the inter-box region.

5. A vehicle comprising the power storage device according to claim 1, wherein the breathing film is located below a center tunnel of the vehicle.

6. The vehicle according to claim 5, wherein at least one end portion of the center tunnel is provided with a lid.
